(19) United States
(12) Patent Application Publication
(10) Pub. No.: US 2021/0209638 A1
(43) Pub. Date: Jul. 8, 2021

(54) SYSTEM AND METHOD FOR CREATING NEWS ARTICLE CONTAINING INDIRECT ADVERTISEMENT

(71) Applicant: Electronics and Telecommunications Research Institute, Daejeon (KR)

(72) Inventors: Joon Ho LIM, Daejeon (KR); Hyun Ki KIM, Daejeon (KR); Min Ho KIM, Daejeon (KR); Hyun KIM, Daejeon (KR); Ji Hee RYU, Daejeon (KR); Kyung Man BAE, Daejeon (KR); Yong Jin BAE, Daejeon (KR); Soo Jong LIM, Daejeon (KR); Myung Gil JANG, Daejeon (KR); Jeong HEO, Daejeon (KR)

(73) Assignee: Electronics and Telecommunications Research Institute, Daejeon (KR)

(21) Appl. No.: 17/101,779

(22) Filed: Nov. 23, 2020

(30) Foreign Application Priority Data
Jan. 8, 2020 (KR) 10-2020-0002588

(51) Int. Cl. G06Q 30/02; G06F 40/30; G06F 40/289; G06F 40/166; G06N 3/08; G06N 3/04

(52) U.S. Cl. CPC G06Q 30/0246; G06F 40/30; G06F 40/289; G06F 40/166; G06N 3/04; G06Q 30/0276; G06Q 30/0273; G06Q 30/0254; G06N 3/08; G06Q 30/0277

(57) ABSTRACT

Provided is a system for creating a news article containing an indirect advertisement, the system including an advertisement database including an advertisement item and an indirect advertisement composed of text matching the advertisement item, an advertisement search unit configured to, when a text-type original news article to be exposed to a webpage is input, search the database for an indirect advertisement candidate matching the original news article and select an advertisement candidate list, an advertisement position determination unit configured to determine a paragraph of the original news article into which a selected advertisement is to be inserted, and an advertisement phrase creation unit configured to create a news article containing an advertisement by inserting the selected advertisement into the paragraph of the original news article and expose the created news article.

### CROSS-REFERENCE TO RELATED APPLICATION

This application claims priority to and the benefit of Korean Patent Application No. 10-2020-0002588, filed on Jan. 8, 2020, the disclosure of which is incorporated herein by reference in its entirety.

### BACKGROUND

### 1. Field of the Invention

The present invention relates to a system and method for generating a news article containing an indirect advertisement, and more particularly, to a system and method for inserting an indirect advertisement into the main body of a news article.

### 2. Discussion of Related Art

As a conventional news advertisement method, a method of visualizing an advertisement image related to the field of a news article in an area other than the content of the article has been used.

For example, as shown in FIG. 1, a fixed advertisement region into which a related advertisement is inserted is separately provided, and a preset advertisement is inserted into a corresponding fixed advertisement region.

Such a conventional news advertisement method, which includes posting an advertisement image outside a news article to induce an interested user to click the image, has a problem in that an advertisement click rate is low.

### SUMMARY OF THE INVENTION

The present invention is designed to solve the conventional problems and relates to a system for creating a news article containing an indirect advertisement, the system being capable of improving indirect advertising effects by searching for an indirect advertisement that fits an exposed news article, inserting a found advertisement into a certain paragraph of the news article, and exposing the news article and the advertisement as one news article.

The present invention is not limited to the above objectives, but other objectives not described herein may be clearly understood by those skilled in the art from the following description.

According to an embodiment of the present invention, there is provided a system for creating a news article containing an indirect advertisement, the system including an advertisement database including an advertisement item and an indirect advertisement composed of text matching the advertisement item, an advertisement search unit configured to, when a text-type original news article to be exposed to a webpage is input, search the database for an indirect advertisement candidate matching the original news article and select an advertisement candidate list, an advertisement position determination unit configured to determine a paragraph of the original news article into which a selected advertisement is to be inserted, and an advertisement phrase creation unit configured to create a news article containing an advertisement by inserting the selected advertisement into the paragraph of the original news article and expose the created news article.

The advertisement search unit classifies a field of the input article and selects an advertisement candidate according to an advertisement policy on the basis of one or more criteria of a unit price, previous exposure statistics, and previous click statistics included in indirect advertisement items.

The advertisement search unit selects a list of advertisement candidates using a deep learning model that maximizes the probability of P(x1, . . . , xN) from a large corpus, as a language model that learns a large amount of text in advance.

The advertisement search unit performs field classification model learning for an article using “cross_entropy (Correct Answer Field Vector Article Text)” loss to perform post-learning and uses a field value greater than or equal to a certain threshold among output field vectors as a recognition result during evaluation.

When the selected advertisement is inserted into the paragraph of the original news article, the advertisement position determination unit predicts similarity between the advertisement and the previous paragraph of the original news article using a post-learning model.

The advertisement position determination unit performs post-learning by constructing consecutive sentence strings in the same article in the form of “Sentence String #1<Separator> Sentence String #2” with a specific probability (α %), learning “Continue=True” as a target variable, extracting Sentence String #1 and Sentence String #2 from other documents with a specific probability (1−α %), constructing the sentence strings in the form of “Sentence String #1<Separator> Sentence String #2,” and learning “Continue=False” as a target variable.

The advertisement position determination unit extracts “Sentence String #1” from a corresponding paragraph of the original news article into which an advertisement article is to be inserted, extracts the text of the advertisement article as “Sentence String #2,” constructs a sentence string pair of “Sentence String #1<Separator> Sentence String #2,” and then utilizes a probability value of “Continue=True” as an advertisement sentence prediction score of the corresponding paragraph.

The advertisement position determination unit, which is a model for computing a probability that an advertisement article will be inserted after a paragraph of the original news article, ignores considering the advertisement sentence prediction for each paragraph as a candidate when the advertisement article appears before the original news article.

The advertisement position determination unit computes an individual score for each paragraph as a document-specific probability distribution by applying softmax function to an advertisement article prediction score vector for each paragraph of the original news article.

The advertisement sentence prediction for each paragraph is configured to output the top N paragraph positions as “n-best insertion position.”

The advertisement phrase creation unit creates an advertisement phrase to be inserted based on the previous paragraph of the original news article and the indirect advertisement composed of text on the basis of a deep learning language model.

The advertisement phrase creation unit operates based on a language model obtained by performing a next-word prediction task for news/advertisement text on the pre-learning language model and learns the next-word prediction task: P (Current Word|Previous Word String).

The advertisement phrase creation unit inputs an advertisement text and a previous paragraph text of the original news article and creates an advertisement phrase to be output by applying a word-based sequential prediction method.

The advertisement phrase creation unit applies a beam-search that creates a maximum of K candidates, and each advertisement phrase does not exceed a maximum of N works.

The advertisement phrase creation unit chooses a final advertisement phrase and chooses an advertisement phrase for each article and each advertisement candidate on the basis of a result of creating an advertisement phrase for each of a plurality of insertion positions.

The advertisement phrase creation unit calculates a score for choosing the final advertisement phrase using Equation 1 below:

P(Paragraph Position Original News Article,Indirect Advertisement Text)×P(Created Advertisement Text|Original News Article,Paragraph Position,Indirect Advertisement Text). [Equation 1]

The advertisement search unit, the advertisement position determination unit, and the advertisement phrase creation unit use a method of post-learning a pre-learning deep learning language model that maximizes P(x1, . . . , xN), which is the probability of a sentence x1, . . . , xN from a large corpus.

According to another aspect of the present invention, there is provided a method of creating a news article containing an indirect advertisement, the method including receiving a text-type original news article to be exposed, searching a database for an indirect advertisement candidate matching the original news article and selecting an advertisement candidate list; selecting a paragraph of the original news article into which a selected advertisement is to be inserted; and inserting the selected advertisement into the paragraph of the original news article to create and expose a news article containing an advertisement.

The selecting of the advertisement candidate list includes classifying a field of the original news article, searching for an advertisement candidate specific to the classified field; and creating a list of found advertisement candidates.

The selecting of a paragraph of the original news article includes computing similarity between the selected advertisement and the previous paragraph of the original news article when the selected advertisement is inserted into each paragraph of the original news article, and determining the paragraph of the original news article into which the selected advertisement is to be inserted on the basis of the computed similarity.

The creating of a news article containing an advertisement includes creating an advertisement phrase for each paragraph of the original news article into which the advertisement is to be inserted, calculating a similarity score of each paragraph of the original news article into which the created advertisement is inserted, and inserting an advertisement created according to the calculated similarity score for each paragraph into the corresponding paragraph of the original news article to create the news article containing the advertisement.

### BRIEF DESCRIPTION OF THE DRAWINGS

FIG. 1 is a functional block diagram illustrating a system for creating a news article containing an indirect advertisement according to an embodiment of the present invention.

FIG. 2 is a flowchart illustrating a method of creating a news article containing an indirect advertisement according to an embodiment of the present invention.

FIG. 3 is a flowchart illustrating an operation of creating a candidate list (S200 in FIG. 2).

FIG. 4 is a flowchart illustrating an operation of selecting an advertisement insertion paragraph (S300 in FIG. 2).

FIG. 5 is a flowchart illustrating an operation of creating a news article containing an advertisement (S400 in FIG. 2).

### DETAILED DESCRIPTION OF EXEMPLARY EMBODIMENTS

Advantages and features of the present invention, and implementation methods thereof will be clarified through the following embodiments described in detail with reference to the accompanying drawings. However, the present invention is not limited to embodiments disclosed herein and may be implemented in various different forms. The embodiments are provided for making the disclosure of the prevention invention thorough and for fully conveying the scope of the present invention to those skilled in the art. It is to be noted that the scope of the present invention is defined by the claims. The terminology used herein is for the purpose of describing particular embodiments only and is not intended to be limiting of the invention. As used herein, the singular forms “a,” “an,” and “one” include the plural unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

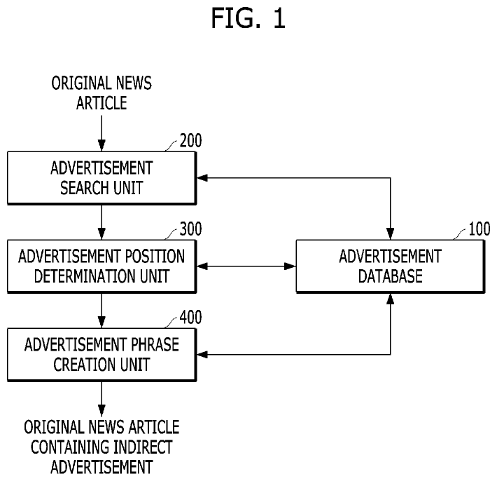

FIG. 1 is a functional block diagram illustrating a system for creating a news article containing an indirect advertisement according to an embodiment of the present invention.

As shown in FIG. 1, a system for creating a news article containing an indirect advertisement according to an embodiment of the present invention includes an advertisement database 100, an advertisement search unit 200, an advertisement position determination unit 300, and an advertisement phrase creation unit 400.

In the advertisement database 100, an advertisement item and an indirect advertisement, which includes text matching the advertisement item, are stored.

In the advertisement database 100, as shown in Table 1 below, an advertisement ID, an advertisement company, a product, a unit price, a field, and indirect advertisement text information are matched and stored.

TABLE 1

| | | | | | Text for Indirect |
|---|---|---|---|---|---|
| Advertisement ID | Company | Product | Unit Price | Field | Advertisement |
| 000001_0001 | Mirae Asset | Stock | KRW 500 per | Finance, | Mirae Asset Daewoo announced |
| | Daewoo | Trading | exposure | Stocks | on the 4th that starting from this |
| | | | | | month, it will hold an event that |
| | | | | | provides new direct non-face-to- |
| | | | | | face customers with a lifetime |
| | | | | | exemption from domestic online |
| | | | | | stock trade fees (excluding |
| | | | | | related institution fees) and with |
| | | | | | up to KRW 20,000 until August |
| | | | | | 30. |
| 000204_0003 | Kia Motors | Seltos | KRW 300 per | Economy, | Kia Motors introduced Seltos, |
| | | | exposure | Vehicle | which is a compact SUV. Seltos |
| | | | | | employs various advanced safety |
| | | | | | specifications such as Advanced |
| | | | | | Driver Assistance Systems |
| | | | | | (ADAS) including forward |
| | | | | | collision prevention or lane |
| | | | | | departure warning, as a default |
| | | | | | setting. The design sense of |
| | | | | | Seltos emphasized sensitivity in |
| | | | | | detail. Seltos has a volume- |
| | | | | | emphasized exterior and a |
| | | | | | luxurious interior, which is |
| | | | | | finally obtained by reinterpreting |
| | | | | | an authentic SUV with a modern |
| | | | | | sense. Long hood compared to |
| | | | | | the overall length (4,375 mm), |
| | | | | | diamond-patterned grille, |
| | | | | | elaborate rear lamp, and dual-tip |
| | | | | | decor garnish attract people's |
| | | | | | attention. |
| 006431_0021 | Renault | QM6 LPG | KRW 1,000 per | Economy, | Renault Samsung's ambitious car |
| | Samsung | | click | Vehicle | is the liquefied petroleum (LPG) |
| | Motors | | | | model of QM6. The only LPG |
| | | | | | sport utility vehicle (SUV) “QM6 |
| | | | | | LPe” in Korea is expected to be |
| | | | | | the leading force that will make |
| | | | | | Renault Samsung No. 1 in the |
| | | | | | LPG automobile market. |

Also, when a text-type original news article to be exposed is input to a webpage, the advertisement search unit 200 searches a database for an indirect advertisement candidate matching the original news article and selects an advertisement candidate list. Here, the advertisement search unit 200 searches for the top n advertisement candidates.

When the advertisement candidate list is selected, the advertisement position determination unit 300 determines a paragraph of the original news article into which a selected advertisement is to be inserted.

Also, the advertisement phrase creation unit 400 creates a news article containing an advertisement by inserting the selected advertisement into the paragraph of the original news article and then exposes the created news article.

According to an embodiment of the present invention, by analyzing and selecting an original news article and an indirect advertisement related to the original news article and providing the selected indirect advertisement included in a paragraph of the original news article, it is possible to increase an advertisement click-through rate while removing heterogeneity between news and advertisement.

Meanwhile, the advertisement search unit 200 according to an embodiment of the present invention may operate based on a model that performs post-learning (fine-tuning) using article-field learning data. Thus, the advertisement search unit 200 performs field classification model learning for an article using “cross_entropy (Correct Answer Field Vector Article Text)” loss during post-learning and uses a field value greater than or equal to a certain threshold among output field vectors as a recognition result during evaluation. Here, a pre-learning language model, which is a language model that learns a large amount of text in advance, may be a deep learning model that maximizes the probability of P(x1, . . . , xN) from a large corpus.

Meanwhile, the advertisement search unit 200 may select an advertisement according to an advertisement policy on the basis of one or more criteria of a unit price, previous exposure statistics, and previous click statistics.

Meanwhile, the advertisement position determination unit 300 inserts the selected advertisement into the paragraph of the original news article and then exposes the news including the advertisement to a webpage. In this case, when the selected advertisement is inserted into the paragraph of the original news article, the advertisement position determination unit 300 uses a model for measuring the degree to which the advertisement matches the previous paragraph. In this case, the advertisement position determination unit may use a pre-learning language model.

Therefore, the advertisement position determination unit 300 operates based on a model that performs post-learning by applying learning data “sentence string pairs” to the pre-learning language model. Here, the post-learning method includes constructing consecutive sentence strings in the same article in the form of “Sentence String #1<Separator> Sentence String #2” with a specific probability (α%), learning “Continue=True” as a target variable, extracting Sentence String #1 and Sentence String #2 from other documents with a specific probability (1−α%), constructing the sentence strings in the form of “Sentence String #1<Separator> Sentence String #2,” and learning “Continue=False” as a target variable.

Conversely, an evaluation method includes extracting a corresponding paragraph of an original news article as “Sentence String #1,” extracting text of an advertisement article as “Sentence String #2,” constructing a sentence string pair of “Sentence String #1<Separator> Sentence String #2,” and utilizing the probability value of “Continue=True” as an advertisement sentence prediction score of the corresponding paragraph.

Here, advertisement sentence prediction for each paragraph is a model for computing a probability that an advertisement article will be inserted after a paragraph of an original news article. In this case, when the advertisement article appears before the original news article, this advertisement article is not considered as a candidate.

In addition, the advertisement position determination unit 300 may use a method of determining an n-nest advertisement insertion position for each document. Here, the method of determining an n-nest advertisement insertion position for each document includes computing an individual score for each paragraph as a document-specific probability distribution by applying softmax function to an advertisement article prediction score vector for each paragraph of the original news article. In this case, the top N paragraph positions may be output as “n-best insertion positions.”

Meanwhile, the advertisement phrase creation unit 400 according to an embodiment of the present invention creates an advertisement phrase to be inserted based on the text-based indirect advertisement and the previous paragraph of the original new article on the basis of the deep learning language model.

In this case, the advertisement phrase creation unit 400 may operate based on a language model obtained by performing a next-word prediction task for news/advertisement text on the pre-learning language model and may learn the next-work prediction task: P (Current Word|Previous Word String).

Also, the advertisement phrase creation unit 400 inputs an advertisement text and a previous paragraph text of the original news article and creates an advertisement phrase to be output by applying a word-based sequential prediction method.

Also, the advertisement phrase creation unit 400 applies a beam-search that creates a maximum of K candidates, and each advertisement phrase does not exceed a maximum of N works.

Also, the advertisement phrase creation unit 400 chooses a final advertisement phrase and chooses an advertisement phrase for each article and each advertisement candidate on the basis of a result of creating an advertisement phrase for each of a plurality of insertion positions.

The advertisement phrase creation unit 400 calculates a score for choosing the final advertisement phrase through Equation 1.

P(Paragraph Position Original News Article,Indirect Advertisement Text)×P(Created Advertisement Text|Original News Article,Paragraph Position,Indirect Advertisement Text) [Equation 1]

According to the present invention, the advertisement search unit, the advertisement position determination unit, and the advertisement phrase creation unit use a method of post-learning a pre-learning deep learning language model that maximizes P(x1, . . . , xN), which is the probability of a sentence x1, . . . , xN from a large corpus.

### Example #1

<Original Article>
Old diesel cars in Seoul are penalized even for parking
. . .
Seoul gives preference to eco-friendly vehicles when choosing a vehicle with
parking priority. Twenty-five autonomous districts implement an “assignment
priority increasing policy” in which Grade 1 emission vehicles are assigned first
or a policy of giving additional points to the overall evaluation score for parking
priority. Grade 1 emission vehicles include electric vehicles, hydrogen vehicles,
and some eco-friendly gasoline and liquefied petroleum gas (LPG) vehicles.
Diesel vehicles do not correspond to Grade 1.
Seoul gives disadvantages to “pollution vehicles,” which are Grade 5 emission
vehicles, for parking. Most of these vehicles are old diesel cars which have been
produced before 2005. It is estimated that the vehicles occupy about 10% (2.47
million) of domestic vehicles.
. . .
<Article Containing Indirect Advertisement>
Old diesel cars in Seoul are penalized even for parking
. . .
Seoul gives preference to eco-friendly vehicles when choosing a vehicle with
parking priority. Twenty-five autonomous districts implement an “assignment
priority increasing policy” in which Grade 1 emission vehicles are assigned first
or a policy of giving additional points to the overall evaluation score for parking
priority. Grade 1 emission vehicles include electric vehicles, hydrogen vehicles,
and some eco-friendly gasoline and liquefied petroleum gas (LPG) vehicles.
Diesel vehicles do not correspond to Grade 1.
On the 17th, Renault Samsung released a partially modified model of QM6,
which is its representative midsize SUV, in three years. With the most interesting
LPG model, “The New QM6 LPe,” the government has eased regulations on
LPG vehicles from March 26th, allowing the general public to purchase LPG
vehicles. The biggest advantage of the QM6 LPe model is its economical
efficiency, and the LPG price is about 56% of the gasoline price. <Link to
Renault Samsung QM6 LPG>
Seoul gives disadvantages to “pollution vehicles,” which are Grade 5 emission
vehicles, for parking. Most of these vehicles are old diesel cars which have been
produced before 2005. It is estimated that the vehicles occupy about 10% (2.47
million) of domestic vehicles.

### Example #2

<Original Article>
Kia Motors' operating profit for the first-half of the year increased by 71% . . .
Reversal of foreign exchange gains and ordinary wages
. . .
Kia Motors is focusing on sales of Zhipao (local strategic semi-midsize SUV),
Yipao (local strategic small SUV), and the new K3, which showed relatively
strong sales, and will introduce Seltos to promote sales recovery.
A company official said, “We will enhance the corporate value and shareholder
value by focusing on the possibility of sustainable growth in an uncertain
business environment and focusing on strengthening of Kia Motors' overall
corporate competitiveness in the future, including efficient investment for the
future.
<Article Containing Indirect Advertisement>
Kia Motors' operating profit for the first-half of the year increased by 71% . . .
Reversal of foreign exchange gains and ordinary wages
. . .
Kia Motors is focusing on sales of Zhipao (local strategic semi-midsize SUV),
Yipao (local strategic small SUV), and new K3, which showed relatively strong
sales, and will introduce Seltos to promote sales recovery.
A company official said, “We will enhance the corporate value and shareholder
value by focusing on the possibility of sustainable growth in an uncertain
business environment and focusing on strengthening of Kia Motors' overall
corporate competitiveness in the future, including efficient investment for the
future.”
Meanwhile, Mirae Asset Daewoo announced that starting from this month, it will
hold an event that provides new direct non-face-to-face customers with a lifetime
exemption from domestic online stock trade fees (excluding related institution
fees) and with up to KRW 20,000 until August 30. <Link to Mirae Asset Daewoo
Event>

### Example #3

<Original Article>
Kia Motors' operating profit for the first-half of the year increased by 71% . . .
Reversal of foreign exchange gains and ordinary wages
. . .
Kia Motors is focusing on sales of Zhipao (local strategic semi-midsize SUV),
Yipao (local strategic small SUV), and new K3, which showed relatively strong
sales, and will introduce Seltos to promote sales recovery.
A company official said, “We will enhance the corporate value and shareholder
value by focusing on the possibility of sustainable growth in an uncertain
business environment and focusing on strengthening of Kia Motors' overall
corporate competitiveness in the future, including efficient investment for the
future.”
<Article Containing Indirect Advertisement>
Kia Motors' operating profit for the first-half of the year increased by 71% . . .
Reversal of foreign exchange gains and ordinary wages
. . .
Kia Motors is focusing on sales of Zhipao (local strategic semi-midsize SUV),
Yipao (local strategic small SUV), and new K3, which showed relatively strong
sales, and will introduce Seltos to promote sales recovery.
Kia Motors launched Seltos, which is a small SUV, on September 18. Seltos
employs various advanced safety specifications such as Advanced Driver
Assistance Systems (ADAS) including forward collision prevention or lane
departure warning. The design of Seltos has a volume-emphasized exterior and a
luxury interior, which is finally obtained by reinterpreting an authentic SUV with
a modern sense. The domestic sales price ranges from KRW 19.29 million to
26.36 million depending on the model by trim. <Link to Kia Seltos>
A company official said, “We will enhance the corporate value and shareholder
value by focusing on the possibility of sustainable growth in an uncertain
business environment and focusing on strengthening of Kia Motors' overall
corporate competitiveness in the future, including efficient investment for the
future.”

According to an embodiment of the present invention, by inserting relevant advertisement text fitting a news article into a certain paragraph of the news article, it is possible to increase a probability that a subscriber will click the advertisement while reading the news.

Also, according to an embodiment of the present invention, by inserting advertisement text into different positions of the same article depending on the advertisement target and by inserting advertisement text fitting the context of the original article, it is possible to maximize advertising effects.

The present invention relates to a technique for inserting an advertisement phrase into the main body of a news article and is applicable by inserting an arbitrary advertisement article in real time when used in an actual service or by creating and storing an article containing an advertisement in advance depending on the news article.

In addition, although the present invention has disclosed a method of inserting an advertisement phrase into the main text of news, it can be easily extended to a method of inserting a plurality of advertisement texts and a method of inserting an advertisement image associated with an advertisement phrase.

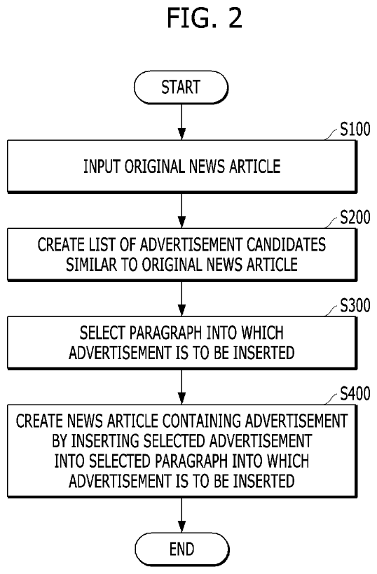

A method of creating a news article containing an indirect advertisement according to an embodiment of the present invention will be described below with reference to FIG. 2.

First, the method includes receiving a text-type original news article to be exposed (S100).

Subsequently, the method includes selecting an advertisement candidate list by searching a database for an indirect advertisement candidate matching the original news article (S200).

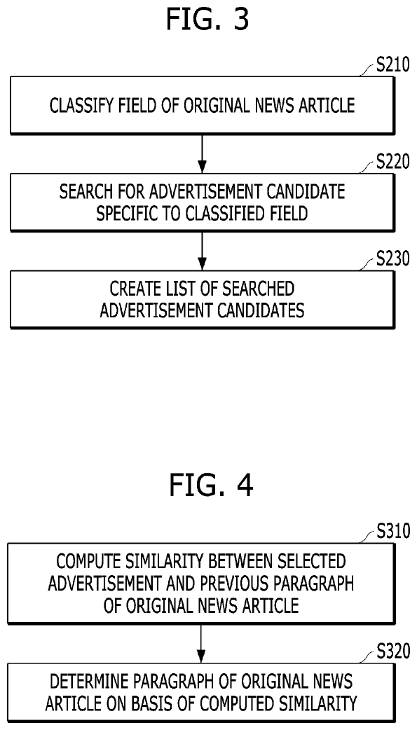

Meanwhile, the selecting of the advertisement candidate list (S200) will be described in detail with reference to FIG. 3.

First, the method includes classifying the field of the original news article (S210).

Subsequently, the method includes searching an advertisement database 100 in which advertisement items and indirect advertisements composed of text matching the advertisement items are stored for an advertisement candidate specific to the classified field (S220).

Subsequently, the method includes a list of found advertisement candidates (S230).

Subsequently, the method includes selecting a paragraph of the original news article into which the selected advertisement is to be inserted (S300).

Meanwhile, the selecting of the paragraph of the original news article (S300) will be described below with reference to FIG. 4.

First, the method includes computing the similarity between the selected advertisement and the previous paragraph of the original news article when the selected advertisement is inserted into each paragraph of the original news article (S310).

Also, the method includes determining a paragraph of the original news article into which the selected advertisement is to be inserted on the basis of the computed similarity (S320).

Subsequently, the method includes creating a news article containing an advertisement by inserting the selected advertisement into the paragraph of the original news article and exposing the news article (S400).

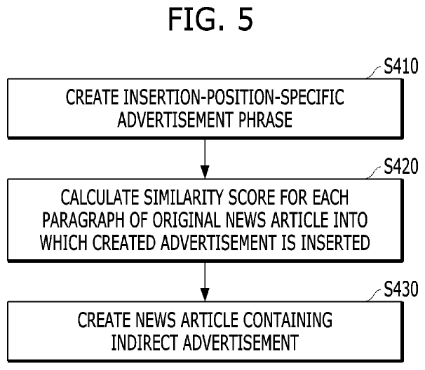

The creating of the news article containing the advertisement (S400) will be described below with reference to FIG. 5.

First, the method includes creating an advertisement phrase for each paragraph of the original news article into which the advertisement is to be inserted (S410).

Subsequently, the method includes calculating a similarity score for each paragraph of the original news article into which the created article is inserted (S420).

The method includes creating a news article containing an indirect advertisement by inserting an advertisement created according to the similarity score for each paragraph into a corresponding paragraph of the original news article (S430).

According to an embodiment of the present invention, by inserting relevant advertisement text fitting a news article into a certain paragraph of the news article, it is possible to increase a probability that a subscriber will click the advertisement while reading the news.

Also, according to an embodiment of the present invention, by inserting advertisement text into different positions of the same article depending on the advertisement target and by inserting advertisement text fitting the context of the original article, it is possible to maximize advertising effects.

Each step included in the learning method described above may be implemented as a software module, a hardware module, or a combination thereof, which is executed by a computing device.

Also, an element for performing each step may be respectively implemented as first to two operational logics of a processor.

The software module may be provided in RAM, flash memory, ROM, erasable programmable read only memory (EPROM), electrical erasable programmable read only memory (EEPROM), a register, a hard disk, an attachable/detachable disk, or a storage medium (i.e., a memory and/or a storage) such as CD-ROM.

An exemplary storage medium may be coupled to the processor, and the processor may read out information from the storage medium and may write information in the storage medium. In other embodiments, the storage medium may be provided as one body with the processor.

The processor and the storage medium may be provided in application specific integrated circuit (ASIC). The ASIC may be provided in a user terminal. In other embodiments, the processor and the storage medium may be provided as individual components in a user terminal.

Exemplary methods according to embodiments may be expressed as a series of operation for clarity of description, but such a step does not limit a sequence in which operations are performed. Depending on the case, steps may be performed simultaneously or in different sequences.

In order to implement a method according to embodiments, a disclosed step may additionally include another step, include steps other than some steps, or include another additional step other than some steps.

Various embodiments of the present disclosure do not list all available combinations but are for describing a representative aspect of the present disclosure, and descriptions of various embodiments may be applied independently or may be applied through a combination of two or more.

Moreover, various embodiments of the present disclosure may be implemented with hardware, firmware, software, or a combination thereof. In a case where various embodiments of the present disclosure are implemented with hardware, various embodiments of the present disclosure may be implemented with one or more application specific integrated circuits (ASICs), digital signal processors (DSPs), digital signal processing devices (DSPDs), programmable logic devices (PLDs), field programmable gate arrays (FPGAs), general processors, controllers, microcontrollers, or microprocessors.

The scope of the present disclosure may include software or machine-executable instructions (for example, an operation system (OS), applications, firmware, programs, etc.), which enable operations of a method according to various embodiments to be executed in a device or a computer, and a non-transitory computer-readable medium capable of being executed in a device or a computer each storing the software or the instructions.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

Although the configuration of the present invention has been described in detail with reference to the accompanying drawings, this is merely an example, and it will be appreciated by those skilled in the art that various modifications and changes may be made therein without departing from the spirit of the present invention. Accordingly, the scope of the present invention should not be limited to the above-described embodiments. Rather, it is to be determined only by the appended claims.

What is claimed is:

1. A system for creating a news article containing an indirect advertisement, the system comprising:
an advertisement database including an advertisement item and an indirect advertisement composed of text matching the advertisement item;
an advertisement search unit configured to, when a text-type original news article to be exposed to a webpage is input, search the database for an indirect advertisement candidate matching the original news article and select an advertisement candidate list;
an advertisement position determination unit configured to determine a paragraph of the original news article into which a selected advertisement is to be inserted; and
an advertisement phrase creation unit configured to create a news article containing an advertisement by inserting the selected advertisement into the paragraph of the original news article and expose the created news article.

2. The system of claim 1, wherein the advertisement search unit classifies a field of the input article and selects an advertisement candidate according to an advertisement policy on the basis of one or more criteria of a unit price, previous exposure statistics, and previous click statistics included in indirect advertisement items.

3. The system of claim 2, wherein the advertisement search unit selects a list of advertisement candidates using a deep learning model that maximizes a probability of P(x1, . . . , xN) from a large corpus, as a language model that learns a large amount of text in advance.

4. The system of claim 1, wherein the advertisement search unit is configured to:
perform field classification model learning for an article using “cross_entropy (Correct Answer Field Vector Article Text)” loss to perform post-learning; and
use a field value greater than or equal to a certain threshold among output field vectors as a recognition result during evaluation.

5. The system of claim 1, wherein when the selected advertisement is inserted into the paragraph of the original news article, the advertisement position determination unit predicts similarity between the advertisement and the previous paragraph of the original news article using a post-learning model.

6. The system of claim 5, wherein the advertisement position determination unit configured to:
perform post-learning by constructing consecutive sentence strings in the same article in the form of “Sentence String #1<Separator> Sentence String #2” with a specific probability (α %) and learn “Continue=True” as a target variable; and
extract Sentence String #1 and Sentence String #2 from other documents with a specific probability (1−α %), construct the sentence strings in the form of “Sentence String #1<Separator> Sentence String #2,” and learn “Continue=False” as a target variable.

7. The system of claim 6, wherein the advertisement position determination unit extracts “Sentence String #1” from a corresponding paragraph of the original news article into which an advertisement article is to be inserted, extracts the text of the advertisement article as “Sentence String #2,” constructs a sentence string pair of “Sentence String #1<Separator> Sentence String #2,” and then utilizes a probability value of “Continue=True” as an advertisement sentence prediction score of the corresponding paragraph.

8. The system of claim 7, wherein the advertisement position determination unit, which is a model for computing a probability that an advertisement article will be inserted after a paragraph of the original news article, ignores considering the advertisement sentence prediction for each paragraph as a candidate when the advertisement article appears before the original news article.

9. The system of claim 8, wherein the advertisement position determination unit computes an individual score for each paragraph as a document-specific probability distribution by applying softmax function to an advertisement article prediction score vector for each paragraph of the original news article.

10. The system of claim 8, wherein the advertisement sentence prediction for each paragraph is configured to output the top N paragraph positions as “n-best insertion position.”

11. The system of claim 1, wherein the advertisement phrase creation unit creates an advertisement phrase to be inserted based on the previous paragraph of the original news article and the indirect advertisement composed of text on the basis of a deep learning language model.

12. The system of claim 10, wherein the advertisement phrase creation unit operates based on a language model obtained by performing a next-word prediction task for news/advertisement text on the pre-learning language model and learns the next-work prediction task: P (Current Word|Previous Word String).

13. The system of claim 12, wherein the advertisement phrase creation unit inputs an advertisement text and a previous paragraph text of the original news article and creates an advertisement phrase to be output by applying a word-based sequential prediction method.

14. The system of claim 13, wherein the advertisement phrase creation unit applies a beam-search that creates a maximum of K candidates, and each advertisement phrase does not exceed a maximum of N works.

15. The system of claim 14, wherein the advertisement phrase creation unit chooses a final advertisement phrase and chooses an advertisement phrase for each article and each advertisement candidate on the basis of a result of creating an advertisement phrase for each of a plurality of insertion positions.

16. The system of claim 15, wherein the advertisement phrase creation unit calculates a score for choosing the final advertisement phrase using Equation 1 below:
P(Paragraph Position Original News Article,Indirect Advertisement Text)×P(Created Advertisement Text|Original News Article,Paragraph Position,Indirect Advertisement Text). [Equation 1]

17. A method of creating a news article containing an indirect advertisement, the method comprising:
receiving a text-type original news article to be exposed;
searching a database for an indirect advertisement candidate matching the original news article and selecting an advertisement candidate list;
selecting a paragraph of the original news article into which a selected advertisement is to be inserted; and
inserting the selected advertisement into the paragraph of the original news article to create and expose a news article containing an advertisement.

18. The method of claim 17, wherein the selecting of the advertisement candidate list comprises:
classifying a field of the original news article;
searching for an advertisement candidate specific to the classified field; and
creating a list of found advertisement candidates.

19. The method of claim 17, wherein the selecting of a paragraph of the original news article comprises:
computing similarity between the selected advertisement and the previous paragraph of the original news article when the selected advertisement is inserted into each paragraph of the original news article; and
determining the paragraph of the original news article into which the selected advertisement is to be inserted on the basis of the computed similarity.

20. The method of claim 17, wherein the creating of a news article containing an advertisement comprises:
creating an advertisement phrase for each paragraph of the original news article into which the advertisement is to be inserted;
calculating a similarity score of each paragraph of the original news article into which the created advertisement is inserted; and
inserting an advertisement created according to the calculated similarity score for each paragraph into the corresponding paragraph of the original news article to create the news article containing the advertisement.
